(19) United States
(12) Patent Application Publication
(10) Pub. No.: US 2013/0318092 A1
(43) Pub. Date: Nov. 28, 2013

(54) Method and System for Efficient Large-Scale Social Search

(71) Applicant: The Board of Trustees for the Leland Stanford, Junior, University, Palo Alto, CA (US)

(72) Inventors: Goel Ashish, Palo Alto, CA (US); Bahmani Bahman, Stanford, CA (US)

(73) Assignee: The Board of Trustees for the Leland Stanford, Junior, University, Palo Alto, CA (US)

(21) Appl. No.: 13/837,702

(22) Filed: Mar. 15, 2013

Related U.S. Application Data
(60) Provisional application No. 61/652,106, filed on May 25, 2012.

(51) Int. Cl. G06F 17/30

(52) U.S. Cl. CPC G06F 17/30619
USPC 707/741

(57) ABSTRACT

To answer search queries on a social network rich with user-generated content, it is desirable to give a higher ranking to content that is closer to the individual issuing the query. Queries occur at nodes in the network, documents are also created by nodes in the same network, and a goal is to find the document that matches the query and is closest in network distance to the node issuing the query. Embodiments of the present invention provide solutions to this problem. After a some offline pre-processing, the system according to an embodiment of the present invention allows for social index operations (e.g., social search queries and insertion and deletion of words into and from a document at any node).

### CROSS-REFERENCE TO RELATED APPLICATIONS

This application claims priority to U.S. Provisional Application No. 61/652,106 filed May 25, 2012, which is hereby incorporated by reference in its entirety for all purposes.

### STATEMENT OF GOVERNMENT SPONSORED SUPPORT

This invention was made with Government support under contracts 0904325 and 0915040 awarded by the National Science Foundation. The Government has certain rights in this invention.

### FIELD OF THE INVENTION

Embodiments of the present invention relate to an efficient scalable real-time social search system.

### BACKGROUND OF THE INVENTION

With the rapid rise of social data in recent years, the social search problem has gained increasingly more attention both in the academic literature and in industry. Some have studied the problem of ranking search results in collaborative tagging networks. Others focus on ranking name search results on social networks. Still others focus on social question and answering. While others consider personalization of search results based on the user's social network and demonstrate advantages in quality in comparison with topic-based personalization. Others have shown effectiveness of social search for personalization of web search.

Shortest path distances have been proposed as a proxy for social graph based personalization. A social search system based on this proxy needs a way to compute or approximate shortest path distances, which has also been an active area of research. Among these, the family of methods known as “approximate distance oracles” are suited for the social search application. The methods in this family preprocess the graph such that any subsequent distance query can be answered quickly.

To solve the social search problem, even given a fast distance oracle, there is still a need to find the closest nodes to the querying node which answer the query. The basic method of using the oracle to find the distances to all the candidates and then finding the closest ones does not scale to today's massive social networks where the number of search result candidates itself can be large. The previous works in the social search literature provide no additional efficiency compared to this basic scheme.

Therefore, there is a need in the art of for a fast an efficient method and system for performing social searches in modern social networks.

### SUMMARY OF THE INVENTION

To answer search queries on a modern social network rich with user-generated content, it is desirable to give a higher ranking to content that is closer to the individual issuing the query. Queries occur at nodes in the network, documents are also created by nodes in the same network, and the goal is to find the document that matches the query and is closest in network distance to the node issuing the query.

Disclosed herein is a partitioned multi-indexing scheme that provides an solution to this problem. For example, with m links in the network, after an offline O(m) pre-processing time, a scheme according to an embodiment of the present invention allows for social index operations (e.g., social search queries, as well as insertion and deletion of words into and from a document at any node), all in time Õ(1). Further, the scheme according to an embodiment of the present invention can be implemented on open source distributed streaming systems such as Yahoo! S4 or Twitter's Storm so that every social index operation takes Õ(1) processing time and network queries in the worst case, and just two network queries in the common case where the reverse index corresponding to the query keyword is smaller than the memory available at any distributed compute node.

In contrast to traditional search where search ranking is primarily based on document-based relevance and quality measures such as tf-idf or PageRank, social search also takes into account the social graph of the person issuing the query, for example, by giving a higher rank to content generated or consumed by proximate users in the social graph. This type of search not only has applications such as name, entity, or content search on social networks, and social question and answering, it is also effective for personalization of a web search. The rapid rise of user-generated content (e.g., on online social networks, blogs, forums, and social bookmarking or tagging systems) has added to the importance of social search. This is reflected not only in the growing academic literature on the topic, but also in the attempts made by both major and small Internet companies, such as Google, Microsoft, Twitter, Aardvark, etc., to develop social search technologies.

An embodiment of the present invention includes a social search system that satisfies as many of the following objectives as possible:
High efficiency and speed at query time
Real-time updatability, to keep up with content being generated or modified
Capability to mix social-graph-based personalization with more traditional (e.g., document-based) relevance and quality measures
High scalability

These and other embodiments and advantages can be more fully appreciated upon an understanding of the detailed description of the invention as disclosed below in conjunction with the attached Figures.

### BRIEF DESCRIPTION OF THE DRAWINGS

The following drawings will be used to more fully describe certain embodiments of the present invention.

FIG. 1 is a block diagram of a computer system on which the present invention can be implemented.

FIG. 2 is an algorithm for performing distance sketching according to an embodiment of the present invention.

FIG. 3 is an algorithm for performing partitioned multi-indexing according to an embodiment of the present invention.

FIG. 4 is an algorithm for performing a partitioned multi-indexing query according to an embodiment of the present invention.

FIGS. 5A-D are graphs illustrating the results for an average depth of a first good result according to an embodiment of the present invention.

FIGS. 6A-F are graphs illustrating the fraction of failed queries for undirected networks according to an embodiment of the present invention.

FIGS. 7A-F are graphs illustrating the fraction of failed queries for directed networks according to an embodiment of the present invention.

FIG. 8 is a block diagram that illustrates components of the social search system according to an embodiment of the present invention.

Show in FIG. 9 is a method for offline distance sketching according to an embodiment of the present invention.

Shown in FIG. 10 is a method for performing partitioned multi-indexing according to an embodiment of the present invention.

Shown in FIG. 11 is a method for performing query answering according to an embodiment of the present invention.

### DETAILED DESCRIPTION OF THE INVENTION

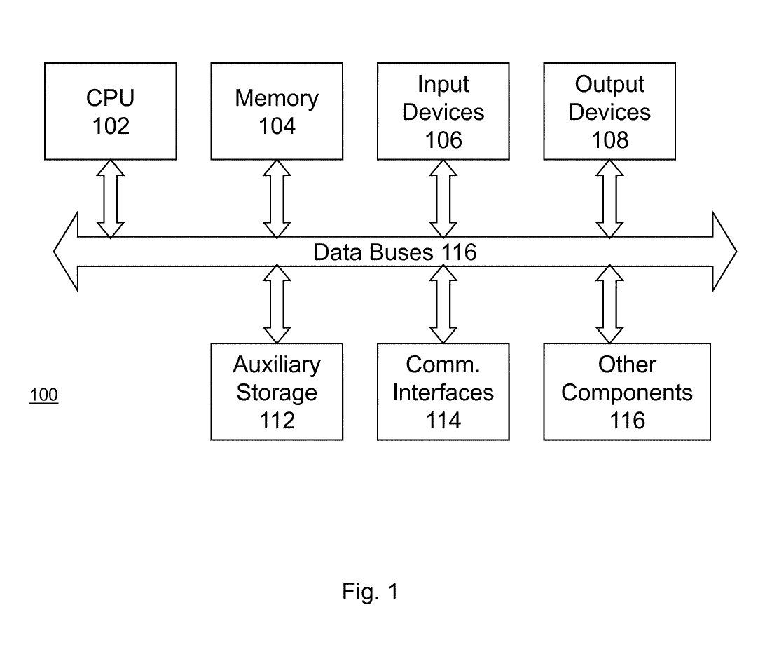

Among other things, the present invention relates to methods, techniques, and algorithms that are intended to be implemented in a digital computer system 100 such as generally shown in FIG. 1. Such a digital computer is well-known in the art and may include the following.

Computer system 100 may include at least one central processing unit 102 but may include many processors or processing cores. Computer system 100 may further include memory 104 in different forms such as RAM, ROM, hard disk, optical drives, and removable drives that may further include drive controllers and other hardware. Auxiliary storage 112 may also be include that can be similar to memory 104 but may be more remotely incorporated such as in a distributed computer system with distributed memory capabilities.

Computer system 100 may further include at least one output device 108 such as a display unit, video hardware, or other peripherals (e.g., printer). At least one input device 106 may also be included in computer system 100 that may include a pointing device (e.g., mouse), a text input device (e.g., keyboard), or touch screen.

Communications interfaces 114 also form an important aspect of computer system 100 especially where computer system 100 is deployed as a distributed computer system. Computer interfaces 114 may include LAN network adapters, WAN network adapters, wireless interfaces, Bluetooth interfaces, modems and other networking interfaces as currently available and as may be developed in the future.

Computer system 100 may further include other components 116 that may be generally available components as well as specially developed components for implementation of the present invention. Importantly, computer system 100 incorporates various data buses 116 that are intended to allow for communication of the various components of computer system 100. Data buses 116 include, for example, input/output buses and bus controllers.

Indeed, the present invention is not limited to computer system 100 as known at the time of the invention. Instead, the present invention is intended to be deployed in future computer systems with more advanced technology that can make use of all aspects of the present invention. It is expected that computer technology will continue to advance but one of ordinary skill in the art will be able to take the present disclosure and implement the described teachings on the more advanced computers or other digital devices such as mobile telephones or “smart” televisions as they become available. Moreover, the present invention may be implemented on one or more distributed computers. Still further, the present invention may be implemented in various types of software languages including C, C++, and others. Also, one of ordinary skill in the art is familiar with compiling software source code into executable software that may be stored in various forms and in various media (e.g., magnetic, optical, solid state, etc.). One of ordinary skill in the art is familiar with the use of computers and software languages and, with an understanding of the present disclosure, will be able to implement the present teachings for use on a wide variety of computers.

The present disclosure provides a detailed explanation of the present invention with detailed explanations that allow one of ordinary skill in the art to implement the present invention into a computerized method. Certain of these and other details are not included in the present disclosure so as not to detract from the teachings presented herein but it is understood that one of ordinary skill in the art would be familiar with such details.

It should be noted that the described embodiments are illustrative and do not limit the present invention. It should further be noted that any method steps described herein need not be implemented in the order described. Indeed, certain of the described steps do not depend from each other and can be interchanged. For example, as persons skilled in the art will understand, any system configured to implement the method steps, in any order, falls within the scope of the present invention.

Efficient Large-Scale Social Search

Given the number of users in a typical social network and the volume of updates, any solution to the presently contemplated search problem must be amenable to a distributed computation. In certain of the description of embodiments below, it will be assumed that an underlying computational substrate is an Active DHT. Other embodiments, however, can be different as would be known to those of ordinary skill in the art. A DHT (Distributed Hash Table) is a distributed (Key, Value) store which allows Lookups, Inserts, and Deletes on the basis of the “Key”. The term Active refers to the fact that, in addition to these DHT operations, an arbitrary User Defined Function (UDF) can be executed on a (Key, Value) pair. The Active DHT model is broad enough to act as a distributed stream processing system and as a continuous version of Map-Reduce, for example. Yahoo's S4 and Twitter's Storm are two examples of Active DHTs which are gaining widespread use. All the (Key, Value) pairs in a node of the active DHT are stored in main memory; this is equivalent to assuming that no one (Key, Value) pair is too large and that the distributed deployment has sufficient number of nodes.

The partitioned multi-indexing scheme according to an embodiment is used for indexing graph structured data which when applied to the problem of social search, satisfies many of the above-mentioned properties. At the core, the scheme is an indexing method which, for any query, allows for quickly finding the closest nodes (to the node issuing the query) in a social graph which answer the query. While the scheme according to an embodiment of the present invention handles social index operations (search, content addition, and content deletion) in real-time, it does not handle social graph updates in real-time; in an embodiment, the social graph is pre-processed (perhaps daily) in a separate initialization step. Other embodiments, however, may perform these operations in real-time.

An embodiment for indexing graph structured data, called partitioned multi-indexing, is based on the oracle introduced by Das Sarma et al. (A. Das Sarma, S. Gollapudi, M. Najork, and R. Panigrahy. A sketch-based distance oracle for web-scale graphs. In WSDM '10, pages 401-410), which allows for an efficient search scheme. A modified scheme according to an embodiment of the present invention inherits two parameters k, r from Das Sarma et al.'s oracle, which, to provide approximation assurances, need to be set to r=log₂ n, k=O(1).

With r=0, this oracle reduces to the landmark-based distance approximation, and the indexing method reduces to an efficient way of finding the search results based on landmark-based approximate distances. In this case, there is no theoretical guarantee on the approximation quality, and the experiments also show that landmark-based approximate distances perform poorly in social search. Potamias et al. study a number of heuristics for landmark selection, and report a centrality-based heuristic to work best across their experiments (M. Potamias, F. Bonchi, C. Castillo, and A. Gionis. Fast shortest path distance estimation in large networks. In CIKM '09, pages 867-876). A modification of this scheme is implemented in an embodiment but no improvement were observed in search quality compared to the random landmark selection scheme, but other applications could yield different results. With r>0, the partitioning property that allows for maintaining space and time efficiency while using whole seed sets instead of single node landmarks to approximate the distances. This leads to significantly higher quality search results.

Before presenting an overview of an embodiment of the present invention, a formal statement of the problem is first presented.

Notations and Problem Statement

There is a (social) graph G=(V, E) with |V|=n, |E|=m. The nodes of this graph may represent people, documents, entities, etc., and the edges may represent friend-ships, page visits, or any other social interactions. For now, assume G to be undirected. Further below, the case of directed graphs will be discussed. Also, the scheme according to an embodiment of the present invention works in the same way and with the same assurances for graphs with weighted edges. So, for simplicity of presentation, the edges are not weighted in an embodiment. Other embodiments, however, can use weighted edges as would be understood by one of ordinary skill in the art upon a full appreciation of the present disclosure.

There is a corpus C=<Cᵥ>vεV, where for each vεV, Cᵥ is the document(s) (e.g. tags, bookmarks, tweets, etc.) associated with node v. Here, it is assumed that Cᵥ is a set of words. Also, words will be allowed to be added to or deleted from the initial corpus from any document over time. This corresponds to, for example, receiving new tweets, bookmarks, or wall posts.

For each word ω:

I(ω)={vεV|ωεCᵥ}

and let l(ω)=|I(ω)|. Furthermore:

|C|=Σ_{vεv}|Cv|=Σ_{ωε∪vC}_{ᵥ}l(ω)

There is also an approximate distance oracle, which for any two nodes u, vεV, outputs \tilde{d}(u, v), an approximation of the shortest path distance d(u, v) between u and v. For now, the choice of this oracle is not restricted in this embodiment, but described further below will be algorithms according to another embodiment based on the oracle discussed above.

Search queries of the form (u, ω, J) will need to be answered, where uεV is the node issuing the query, ω is the word being queried, and J≧0, an integer, is the desired number of search results for the query. Each search result is a node vεI(ω), and it is desired to find, among all such nodes, the J nodes having the smallest approximate distances to u (as measured by d(u, •)), and return them in a ranked list sorted in the increasing order of approximate distance to u. It is assumed that J≦l(ω), as l(ω) is the maximum possible number of search results for the query.

Having set all the necessary notation, the problem statement is then as follows:
Real-Time Social Search Problem—Preprocess the social graph G and the corpus C in a space and time efficient way to construct a data structure that allows for:
1. Answering a social search query quickly
2. Distributed storage and processing in an Active DHT
3. Fast incremental updates, e.g., as soon as words are added to or deleted from any document
   Having presented the formal statement of the basic problem, an overview of a solution scheme will be addressed.

Overview

A high level overview of the scheme according to an embodiment, called partitioned multi-indexing, is presented. The scheme has an offline phase and a query phase. In the offline phase:
1. A number of random seed sets S₀, . . . , Sₕ₋₁⊂V is selected. The number of these sets, h, and the cardinality of each set are specified further below.
2. ∀uεV, 0≦i<h, compute Lᵢ[u], the closest node to u among all the nodes in Sᵢ, and Dᵢ[u]=d(u, Lᵢ[u]). This can be accomplished using O(h) calls to a breadth first search subroutine.
3. ∀0≦i<h,xεSᵢ, an inverted index, I_{i,x}, is constructed over all documents stored at nodes vεV which are closer to x than to any other node in Sᵢ. For each indexed word w, the corresponding list of nodes, I_{i,x}(ω), will be kept in the increasing order of distances to x, and these distances will also be stored in this list.

Then, at query time, when a node u issues a query, the indexes I_{i,Li}[u] (0≦i≦h−1) are used, e.g., intuitively speaking, the closest indices to u, to find the search results. It will be shown that since u is closer to Lᵢ[u] than to any other node in Sᵢ, and also the nodes in each entry of I_{i,Li}[u] are sorted in terms of their distance to Lᵢ[u], then at query time, the search results can be found by sweeping through the beginning nodes in the index entries being looked up. This results in a fast search algorithm at query time. It will, furthermore, be shown that the index allows for fast incremental updates upon addition or deletion of words.

Note that, for each 0≦i<h, any node xεSᵢ indexes a different part of the graph (e.g., the part closer to x than to any other node in Sᵢ), and also, every node u in the graph is indexed at one node of Sᵢ, e.g., the one closest to u. This means that the union of the indexes constructed at the nodes in each Sᵢ (0≦i<h) constitutes a full inverted index of the graph, partitioned across different nodes of Sᵢ. Thus, in the offline phase, h inverted indexes are constructed, each partitioned across the nodes of one seed set. Hence, the name partitioned multi-indexing for the scheme according to an embodiment of the present invention.

Quite interestingly, this schemes maps to an Active DHT. Consider (for illustration) the common scenario where the reverse index corresponding to any word has size smaller than the amount of main memory of each individual node in the Active DHT. Then, the query word w can be used as the key used to store the part of each index I_{i,v} which pertains to ω. This allows us to perform social index operations using just two network calls, without any corresponding increase in the total processing time. This is important because small network data transfers such as the one needed here are often more expensive than large network transfers in terms of data rate. This careful mapping of the social search problem onto a practically feasible distributed computing platform is a significant contribution.

Results

The partitioned multi-indexing scheme for indexing graph structured data according to an embodiment of the present invention not only has strong theoretical guarantees, but also, when applied to the social search problem, satisfies many of the properties mentioned above for a preferred social search engine. The scheme according to an embodiment of the present invention consists of an offline preprocessing phase and an online query phase. It is shown that given a (social) graph G and a corpus C, the preprocessing phase requires Õ(m+|C|) time and O(n+|C|) space. The O(•) notation hides factors that are poly-logarithmic in m. After preprocessing, whenever any node u queries for any word ω, the top J personalized results can be found in Õ(J) time. Also, in the distributed setting, the number of network accesses and the total amount of communication needed to answer the query are, respectively, 2 and Õ(J).

Also, the index can be quickly updated whenever a word is added to or deleted from a document in the corpus. More exactly, updating the index upon each word addition or deletion can be done in Õ(1) time, and in the distributed setting, the total number of network accesses and the total amount of communication required per update are, respectively, 2 and Õ(1).

There are various shortest path oracles, and it is not clear up front which, if any, can be extended to social search, especially with the constraints of distributed implementation, real-time index updates, and mixing in other relevance features. An advantage of embodiments of the present invention lie in identifying the correct oracle and adapting it to obtain each of the desired properties with strong theoretical assurances.

In addition to theoretical bounds, an empirical study of the scheme according to an embodiment is performed to evaluate its efficiency and its quality. Synthetic data is used as well as data from the social network Twitter. On both sets of networks and for both evaluation criteria, the scheme according to an embodiment of the present invention performs better than the theoretical bounds would suggest. Hence, the scheme according to an embodiment can indeed facilitate large scale, real-time social search.

Preliminaries

One of the ingredients of the social search problem is an approximate distance oracle \tilde{d}(•, •). Given such an oracle, to solve the social search problem, it is necessary to quickly find the nodes answering the query which have the smallest approximate distances to the querying node. To do so, a basic personalized social search scheme can be defined as follows.

Baseline Social Search Scheme: The scheme is includes an offline phase and a query phase. At the offline phase, a single inverted index I is constructed, which maps each word ω to the list I(w) of all the nodes v having w in their associated document Cᵥ. At query time, receiving a query (u, ω, J) issued by the node u for the word ω, one goes through the list at the entry I(ω) of the pre-computed index, for each node vεI(ω) uses the oracle to compute \tilde{d}(u, v), and keeps the top results in a priority queue of size J. This baseline scheme is inefficient for query processing; however, it is a useful benchmark against which to compare the pre-processing efficiency and the quality of the scheme according to an embodiment of the present invention.

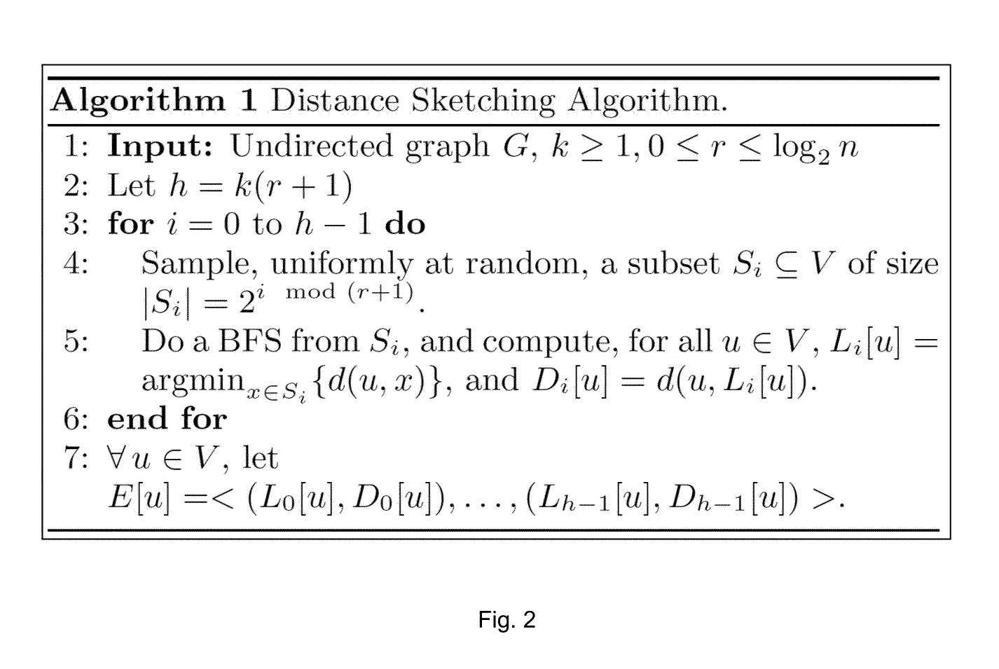

Das Sarma et al.'s Distance Oracle: This oracle has two integer parameters k≧1, 0≦r≦log₂ n. It first pre-processes the graph offline. Shown in FIG. 2 is Algorithm 1 according to an embodiment of the present invention for distance sketching. The preprocessing, presented in Algorithm 1, picks a number, h=k(r+1), of random sub-sets Sᵢ (0≦i<h) of the graph, and by performing a BFS from each one, computes, for each node uεV, the closest node to u in Sᵢ, Lᵢ[u], as well as Dᵢ[u]=d(u, Lᵢ[u]). Note that, since each BFS takes O(m) time (assuming m=Ω(n), which is the case in all networks of current interest), the time and space complexity of Algorithm 1 are, respectively, O(hm) and O(hn).

Afterwards, for any two nodes u, vεV, their approximate distance is computed as follows:

\tilde{d}(u,v)=min{Dᵢ[u]+Dᵢ[v]|0≦i<h,Lᵢ[u]=Lᵢ[v]} (2.1)

In the further discussion below, it will be denoted h=k(r+1). For this oracle, independent of the choice of parameters k, r, ∀u, vεV:\tilde{d}(u, v)≧d(u, v). If r=0, this oracle reduces to the landmark-based distance approximation. Others prove approximation guarantees for this case (even with small values of k), but their result, which assumes the graph to have a bounded doubling dimension, does not apply to social graphs which exhibit expander properties. However, increasing the value of r makes the approximation tighter, and Das Sarma et al. prove the following theorem:

Theorem 1. For \tilde{d}(•, •) defined in equation 2.1, with r=|log₂ n| and k=Õ(n^{1/c}) (with any c>1), with high probability (i.e., probability at least 1−1/n^{O(1)}), for any two nodes u, v:

d(u,v)≦\tilde{d}(u,v)≦(2c−1)d(u,v)

Letting c=O(log n), this provides the following.

Corollary 2. To guarantee an O(log n) approximation factor for the oracle defined by Algorithm 1 and formula 2.1, one can choose r=|log₂ n|, and k=O(1).

Das Sarma et al. observe that in practice this scheme (with r, k chosen as in corollary 2) provides better approximation factors than is guaranteed in theory. This means one can expect that ranking the search results based on this oracle will also result in high quality search results. The experiments discussed below verify this.

Partitioned Multi-Indexing

An overview of the scheme according to an embodiment was presented above. Here, the scheme is presented with more detail and analyzed. The discussion here starts with a definition.

Definition 3. For any 0≦i<h, node zεSᵢ, and word ω, define:

I_{i,z}(ω):={vεV|ωεCᵥ,Lᵢ[v]=z}

and let l_{i,z}(ω)=|I_{i,z}(ω)|. Denote

I_{i,z}(ω)={x_{i,z}^{r}(ω)}1≦r≦l_{i,z}(ω)

where d(z, x_{i,z}¹(ω))≦d(z, x_{i,z}²(ω))≦ . . . ≦d(z, x_{i,z}^{li,z(w)}(ω)).

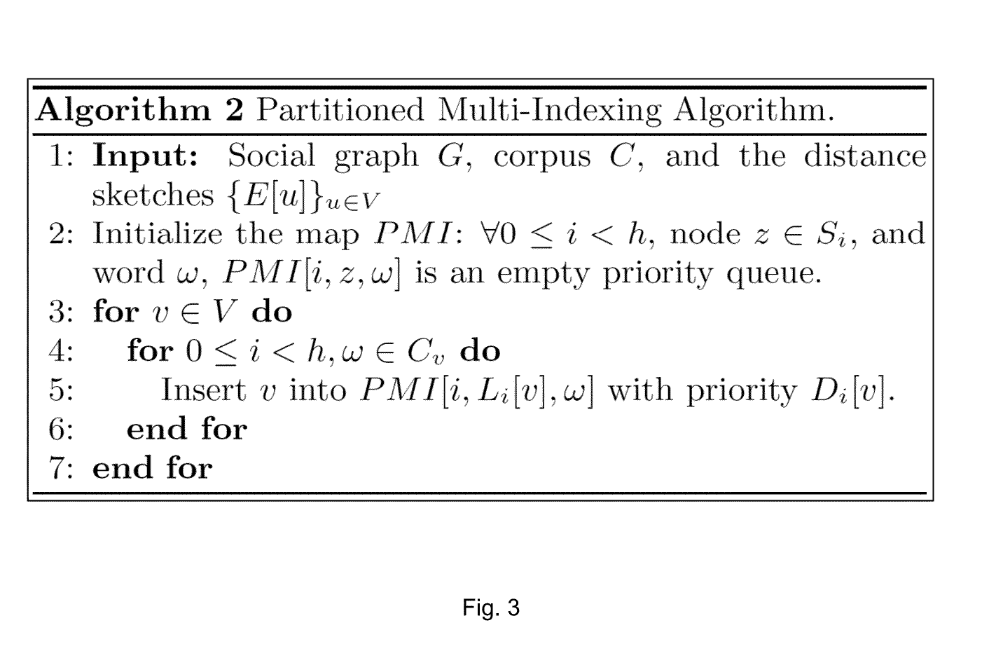

The scheme is composed of an offline phase and a query phase. The offline phase of the scheme constructs a map (i.e., an index) PMI which, for any 0≦i<h, node zεSᵢ, and word ω, such that I_{i,z}(ω)≠Ø, maps (i, z, ω) to the list of nodes in I_{i,z}(ω), sorted in the increasing order of distance to z. This partitioned multi-indexing algorithm is presented as Algorithm 2 as shown in FIG. 3. It will later be shown that the constructed index will allow for a fast query answering algorithm. But, before that, the space and time complexities of the offline phase will be analyzed.

Offline Phase Analysis: The space and time complexity of Algorithm 2 as shown in FIG. 3 according to an embodiment is analyzed here. This discussion starts with a lemma.

Lemma 4. For any 0≦i<h, and word ω, {I_{i,z}(ω)}_{z}εSᵢ partitions I(ω), that is

∪_{z}εSᵢI_{i,z}(ω)=I(ω)

∀z,z′εSᵢ,z≠z′:I_{i,z′}(ω)∩I_{i,z}(ω)=Ø

Proof. The result follows from the observation that any node vεI(ω), appears in I_{i,Li[v]}(ω), and in no other I_{i,z}(ω)(zεSᵢ).

Using this lemma, there is the following result.

Proposition 5. For Algorithm 2:
The space complexity is O(h|C|)
The time complexity is O(hΣ_{ωε∪}_{ᵥ}_{C}_{ᵥ}l(ω) log l(ω))

Proof Fix an 0≦i<h. For any node zεSᵢ and word ωε∪ᵥCᵥ, the space and time used to construct PMI[i, z, ω] are, respectively, equal to O(l_{i,z}(ω)) and O(l_{i,z}(ω)log l_{i,z}(ω)). Hence, by the previous lemma, the total space and time used to construct all queues PMI[i, z, ω](∀zεSᵢ, ωε∪ᵥCᵥ), are, respectively,

O(Σ_{ωε∪}_{ᵥ}_{C}_{ᵥ}Σ_{zεS}_{ᵢ}l_{i,z}(ω))=O(Σ_{ωε∪}_{ᵥ}_{C}_{ᵥ}l(ω))=O(|C|)

and

O(Σ_{ωε∪}_{ᵥ}_{C}_{ᵥ}Σ_{zεS}_{ᵢ}l_{i,z}(ω)log l_{i,z}(ω))=O(Σ_{ωε∪}_{ᵥ}_{C}_{ᵥ}l(ω)log l(ω))

Then, considering all 0≦i<h proves the proposition.

Choosing the values of r, k as in corollary 2, both space and time complexities of the indexing scheme are within O(1) factor of the baseline indexing method. Furthermore, it will next be shown that the index according to an embodiment of the present invention leads to a significantly faster search algorithm at query time.

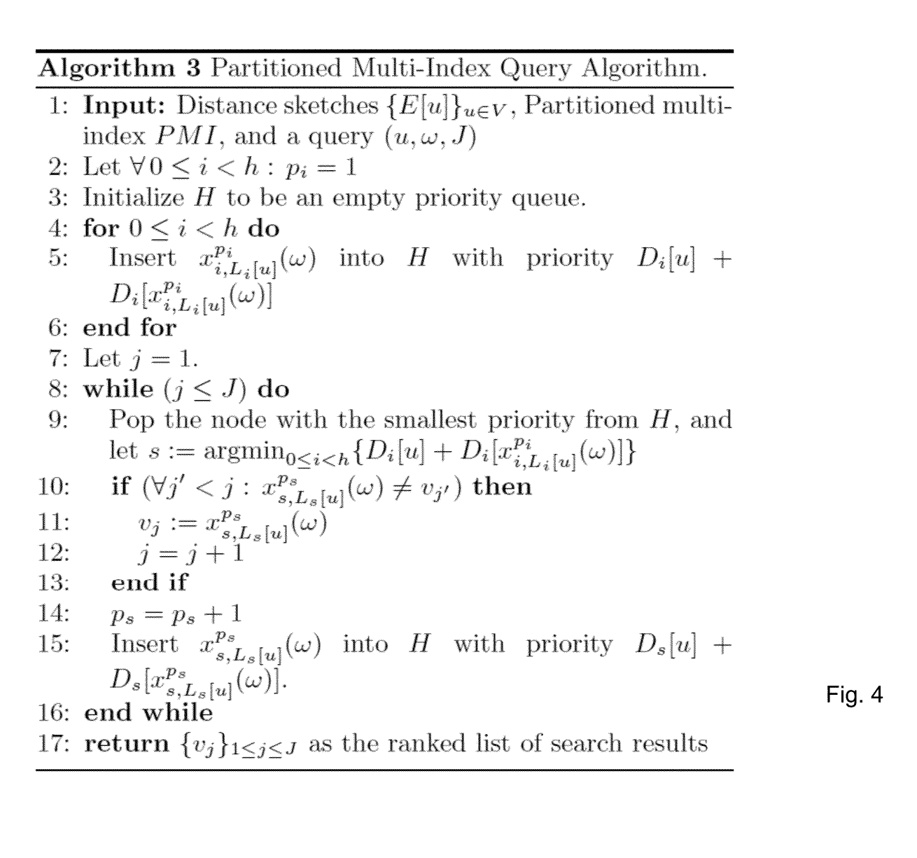

The partitioned multi-index query algorithm according to an embodiment of the present invention is presented as Algorithm 3 as shown in FIG. 4. Briefly speaking, upon receiving a query (u, ω, J), we sweep through the queues PMI[i, Lᵢ[u],ω] (0≦i<h) until the top J results are found. More elaborately, upon receiving the query, a priority queue His initiated that will keep track of the (next) top result candidates as well as h pointers pᵢ (0≦i<h), where pᵢ points to the beginning of the sorted list PMI[i, Lᵢ[u], ω], i.e., the node x l(ω) which is added, i,Lᵢ[u] with priority Dᵢ[u]+Dᵢ[x_{iL}_{ᵢ}_{[u]}¹(ω)], to H. The node is then popped with the lowest priority, say x_{iL}_{ᵢ}_{[u]}¹(ω), from H, report it as the top search result, forward pᵢ₁, and add the node it is now pointing to, i.e., x_{iL}_{ᵢ}_{[u]}²(ω) to H, with priority Dᵢ₁[u]+Dᵢ₁[x_{i1L}_{ᵢ₁}_{[u]}²(ω)]. The node is then popped with the lowest priority from H. It is then reported as the second top result (unless it happens to be the same as the first result), the corresponding pointer forwarded, and so on. This is continued until J results are found. Next, this algorithm is analyzed.

Query Phase Analysis: We first prove that the search Algorithm 3 as shown in FIG. 4 actually works correctly. First a definition.

Definition 6. For a query (u, ω, J), two sets of ranked results {vⱼ}₁≦j≦J, and {v′ⱼ}1≦j≦J, are said to be equivalent, and write {vⱼ}₁≦j≦J˜{v′ⱼ}₁≦j≦J, if ∀1≦j≦J:\tilde{d}(u, vⱼ)=\tilde{d}(u, v′ⱼ).

Essentially, an equivalent pair of search result sets are equally good and cannot be distinguished as far as (approximate) distances to the querying node are concerned. Now, the correctness of Algorithm 3 as shown in FIG. 4 according to an embodiment is proved.

Theorem 7. For a query (u, ω, J), assume {\tilde{v}ⱼ}₁≦j≦J, is the true ranked list of search results according to \tilde{d}(u, •), and {vⱼ}₁≦j≦J is defined as in Algorithm 3. Then, {vⱼ}₁≦j≦J˜{\tilde{d}ⱼ}₁≦j≦J.

Proof. We need to prove that ∀1≦j≦J:\tilde{d}(u, vⱼ)=\tilde{d}(u, \tilde{d}ⱼ). We first prove this for j=1. Let:

i₁=argmin {Dᵢ[u]+Dᵢ[\tilde{v}₁]|0≦i<h,Lᵢ[u]=Lᵢ[\tilde{v}₁]}

Then, we have:

$$\begin{matrix}\tilde{d} ( u , {\tilde{υ}}_{1} ) = {D}_{{i}_{1}} [ u ] + {D}_{{i}_{1}} [ {\tilde{υ}}_{1} ] \\ \geq {D}_{{i}_{1}} [ u ] + {D}_{{i}_{1}} [ {x}_{{i}_{1} , {L}_{{i}_{1}} [ u ]}^{1} ( ω ) ] \\ \geq \tilde{d} ( u , {x}_{{i}_{1} , {L}_{{i}_{1}} [ u ]}^{1} ( ω ) ) \\ \geq \tilde{d} ( u , {υ}_{1} ) \geq \tilde{d} ( u , {\tilde{υ}}_{1} )\end{matrix} \qquad ( 2 )$$

where the first line is by definition of \tilde{d}(u, \tilde{v}1), the second is by definition of x_{x1,Li1[u]}¹(ω), the third is by definition of \tilde{d}(u, x_{x1,Li1[u]}¹(ω)), the fourth is by definition of v₁, and the last is by definition of \tilde{v}₁.

Therefore, \tilde{d}(u, v₁)=\tilde{d}(u, \tilde{v}₁), that is, v₁ indeed has the smallest approximate distance to u among all the nodes in I(ω). Now, notice that to find v₂, the algorithm is essentially removing v₁ from I(ω), and finding the node having the smallest distance to u among the rest of the nodes in I(ω), in exactly the same way as it found v₁. A simple induction then proves the result for general 1≦j≦J. Hence, Algorithm 3 outputs a correct ranking.

Next, the time complexity of Algorithm 3 is analyzed.

Proposition 8. The worst case running time of Algorithm 3 is O(Jh(log l(ω)+log h)).

Proof. Reading each node from PMI takes O(log l(ω)) time. Also, adding a node to or popping a node from H takes O(log h) time. During the run of algorithm, each search result is read from PMI, and added to or popped from H at most h times. Also, the total number of nodes that get read from PMI and added to H but do not show up in the search results is at most h. Hence, the total running time of the algorithm is at most O(Jh(log l(ω)+log h))+O(h(log l(ω)+log h))=O(Jh(log l(ω)+log h)).

Remark 9. Choosing r, k as in corollary 2, we get that the total query time is just Õ(J). Using the baseline scheme with the same oracle, the query time would be O(l(ω)). In today's huge social networks, one can easily expect I(ω), e.g., the number of nodes the word w appears on, to be much (even orders of magnitude) larger than J. For instance, in a name search application on a huge social network, there may be tens or hundreds of thousands of people sharing a same name, but the querying node may be interested only in at most the top 10-20 results. Hence, the scheme according to an embodiment of the present invention is expected to be significantly faster at query time in practice. The experimental results, presented further below, verify this as well.

Remark 10. The same analysis as in proposition 8 shows that if the first J results are already found, then by keeping the values of the pointers in the algorithm, finding the next J′ results will take only O(J′h(log l(ω)+log h)). This feature can be useful in practice. For instance, the search engine can first generate the results to be presented on the first results page, and then only if the user decides to proceed to the next page, it can, at that time, quickly compute the results to be presented in the next page, and so on.

Having analyzed the query phase of the scheme according to an embodiment of the present invention, it will next be shown that the indexing scheme according to an embodiment also allows for fast incremental updates upon addition or deletion of words to the documents.

Incremental Updates: So far focused has been placed on the case where the documents were static, that is, the sets G did not change over time. Here, it is shown that any changes to these sets can be efficiently reflected in the index according to an embodiment of the present invention. This is more formally stated in the following proposition.

Proposition 11. If a word ω is added to (or removed from) Cᵥ, for some vεV, the index can be updated in O(h log l(ω)) time to incorporate this insertion (or deletion).

Proof. To update the index, it is only needed to update the queues PMI[i, Lᵢ[v], ω] (0≦i<h), by adding (or removing) v with priority Dᵢ[v]. Updating the queue PMI[i, Lᵢ[v], ω] takes O(log l_{i,Li}[v](ω))=O(log l(ω)) time. Hence, the total update time is O(h log l(ω)).

Choosing the parameters r, k as in corollary 2, it is seen that the update time is just Õ(1). Hence, the index can be updated quickly as soon as any of the documents in the network gets modified. Several interesting extensions will now be discussed.

Extensions

Directed Graphs: So far, the social graph G was assumed to be undirected. But the scheme according to another embodiment of the present invention can be extended to directed graphs. The experiments discussed here show the scheme according to an embodiment of the present invention also works well for directed graphs.

The sketching algorithm, presented in Algorithm 1 of FIG. 2, gets modified such that instead of computing Lᵢ[u],Dᵢ[u] using a single BFS, at line 5, Lᵢ^{o} [u],Dᵢ^{o}[u] is computed via a BFS along incoming edges, and Lᵢⁱ[u], Dᵢⁱ[u] via a BFS along outgoing edges. The quantities Lᵢ[u],Dᵢ[u] can then be used at indexing time and the quantities Lᵢ^{o}[u],Dᵢ^{o}D[u] at query time to obtain a heuristic solution for directed graphs. Simulation results show that this heuristic works well in practice.

Combining Personalization with Other Relevance Measures: So far, focus has been placed on ranking the search results only based on their distance to the querying node. In practice, however, a combination of distance and other relevance measures is used to rank the results. These relevance measures can be text-based scores such as tf-idf, link-based authority scores such as PageRank, or, in a real-time setting (where more recent results are of more interest) the recency of the document. Here, it is shown how the scheme according to an embodiment can be extended to allow for elegantly combining all such measures with the distance-based personalization, without any change in space or time efficiency.

Assume that associated with each vεV and ωεCᵥ is a score aᵥ(ω) (a real number), hence the following combined score is used to rank search results:

s_{u,ω}(v)=λd(u,v)+(1−λ)aᵥ(ω)

For a query (u, ω, J), the J nodes vεI(ω) with the smallest values of s_{u,ω}(v) need to be found. Here, λε[0, 1] is a weight trading off between distance-based personalization and document-based scores, and in practice is learned from the data to optimize the search quality. Replacing the exact distance with its approximation, the following approximate scores can be used:

\tilde{s}_{u,ω}(v)=λ\tilde{d}(u,v)+(1−λ)aᵥ(ω)

And:

\tilde{s}_{u,ω}(v)=min{λDᵢ[u]+(λDᵢ[v]+(1−λ)aᵥ(ω))}

where, as before, min is over {0≦i<h|Lᵢ[u]=Lᵢ[v]}. To rank based on this score, the indexing Algorithm 2 of FIG. 3 is modified such that at line 5, for example, v is inserted into PMI[i, Lᵢ[v], ω] with priority

πᵥ(ω)=λDᵢ[v]+(1−λ)aᵥ(ω)

Also, the search Algorithm 3 of FIG. 4 is modified such that the priority of each x_{i,Li[u]}^{pi}(ω) in H is

λDᵢ[u]+πᵥ(ω)=λDᵢ[u]+λDᵢ[v]+(1−λ)aᵥ(ω)

Then, a similar analysis as in theorem 7 shows that these modified algorithms rank the results based on \tilde{s}_{u,ω}(v). The space and time complexities of these algorithms are also the same as Algorithms 2 and 3.

### Example 12

The scores aᵥ(ω) can represent a whole range of document-based scores. Here, the real-time search scenario is considered where associated with each node vεV and word ωεCᵥ is a timestamp tᵥ(ω) representing the time instance at which the word ω was added to Cᵥ, and upon receiving a query (u, ω, J) at time t, it is desired to not only personalize the results but also bias the results towards the more recent documents.

At the time of query, the recency of ω on vεI(ω), is t−tᵥ(ω) (note that tᵥ(ω)≦t, as ω is already in Cᵥ when the query arrives). Hence, it is desired to rank the results based on λd(u, v)+(1−λ)(t−tᵥ(ω)). Since t is independent of v, ranking based on this score is exactly the same as ranking based on λd(u, v)+(1−λ)(−tᵥ(ω)). Hence, letting aᵥ(ω)=−tᵥ(ω), the framework explained above to do the search and ranking can be used. This together with the possibility of quick incremental index updates explained earlier in the paper (which lets each new word ωεCᵥ to be indexed as soon as it arrives, e.g., at time tᵥ(ω)), allows for a real-time personalized social search system.

Distributed Implementation: In order to scale up the scheme according to an embodiment of the present invention to today's huge social networks, it is desirable to implement the methods and algorithms described here in a distributed fashion. Since finding the sketches, using Algorithm 1, only requires a number of BFS's, it can adopt a distributed implementation, e.g., using MapReduce. Hence, focus is placed on implementing the rest of the scheme in a distributed fashion, on an Active DHT.

Note that the offline index construction can be regarded as a sequence of word additions. So, if real-time updates can be done efficiently, the offline phase can be done efficiently as well. Hence, focus will first be placed on efficient distributed implementation of query and update algorithms. Later, it will be shown that the offline phase can be done even more efficiently than through a sequence of real-time updates.

For a distributed implementation of the scheme according to an embodiment, both the distance sketches and the index entries need to be shard across a number of machines in an Active DHT, using appropriate (Key, Value) pairs. As pointed out above, it is desired to shard in a way that not only the loads (in terms of space) on different machines are balanced, but also answering queries or updating the index can be done with little network usage, e.g., both few network accesses and small amount of communications. It will be shown that sharding the distance sketch using the id of the querying social graph node as the Key, and the inverted index using the word w as the Key, satisfies all these properties, and results in surprising efficiency bounds.

To formalize this, the following architecture is considered: there is one master machine, which interfaces the outside world, and a set of M machines, labeled 0, 1, . . . , M−1, which can be used to distribute the data structures. Two hash functions f will be used: V→[M], g: ∪ᵥCᵥ→[M] (where [M]={0, 1, . . . , M−1}) to distribute the data structures as follows:
The entry E[u] of the distance sketch is kept on machine f(u)
For any ωε∪ᵥCᵥ, all the entries PMI[i, x, ω] of the index, where 0≦i<h,xεSᵢ, are kept on machine g(ω)

Here, f, g are assumed to be random hash functions. It will further be assumed that the reverse index corresponding to any word w is smaller than the amount of memory at any compute node. This assumption is only for a clean illustrative statement of the results. The index for ω can be fanned out into multiple nodes at the expense of an extra network call if needed. Then, a Chernoff bound shows that, with high probability, the load (e.g., space used) on each machine is

$$Θ ( \frac{h ( n + \vert C \vert )}{M} ) .$$

Hence, the load is well balanced across different machines. Also, note that choosing r, k as in corollary 2, this is just

$$\tilde{Θ} ( \frac{( n + \vert C \vert )}{M} ) ,$$

which is close to what would be needed to only distribute the corpus across the machines. Next, it is shown that answering queries and updating the index can be done with little network usage.

At query time, when the master machine receives a query (u, ω, J), it will first retrieve E[u] by accessing the machine f(u) once. Note that, by Algorithm 3, the top J results for the query are definitely in the set

{x_{i,Li[u]}^{j}(ω)|0≦i≦h−1,1≦j≦J}

Hence, after retrieving E[u], the master machine can retrieve the above set by sending the query along with {Lᵢ[u]|0≦i≦h−1} to machine g(ω). Having retrieved this set, the master machine can then run Algorithm 3 to find and rank the search results. Hence, the total number of network accesses and the total amount of communication needed to answer the query are, respectively, 2 and O(Jh). Note that choosing r, k as in corollary 2 bounds the total amount of communication at Õ(J), which is only slightly more than what would be needed to just communicate the search results (i.e. Ω(J)). This implementation can be done on top of a Distributed Hash Table such as memcached. Further improvements can be obtained by assuming that the DHT is Active; in this case, the set E[u] can be directly communicated to the compute node g(ω) which will perform the search operation, resulting in a total network transfer of O(J+h).

Next, the required network usage is considered to update the index. If a word ω is added to or deleted from the document at node uεV, e.g., Cᵤ, then to update the index, first E[u] is retrieved from machine f(u), and then u and ω are sent along with E[u] to machine g(ω), which can then insert or delete u into or from all the queues PMI[i, Lᵢ[u], ω] (0≦i<h). Hence, the total number of network accesses and the total amount of communication required to update the index are, respectively, 2 and O(h). Choosing r, k as in corollary 2 then bounds the total amount of communication at Õ(1).

As mentioned above, offline index construction can be regarded as a sequence of index updates. Hence, directly using the above update scheme, the offline phase can be done with a total of 2|C| network accesses, and O(h|C|) communications. By accessing the sketch of each node only once, the offline phase can be done even more efficiently: for each node u, E[u] is retrieved by communicating with machine f(u) once, and then for each word ωεCᵤ, u, ω, and E[u] are sent to machine g(ω) to be indexed. Hence, the offline phase can be done with only n+|C| network accesses and O(h|C|) total communications, which reduces to Õ(|C|) communications, by choosing r, k as in corollary 2.

Experiments

Experiments were performed with schemes according to embodiments of the present invention to study their quality and efficiency in practice, especially in comparison with the benchmarks from the related literature. The algorithms, datasets, and the methodology used in these experiments are presented here as well as their results.

Algorithms

As explained further above, landmark-based distance approximation, together with the baseline search scheme, has been proposed as a solution to the social search problem. Thus, in the experiments described here, the quality of the scheme according to an embodiment was compared with the landmark-based scheme. The simplest way of selecting landmarks is by picking them randomly from the graph. In addition to the random landmark selection method, a centrality-based method was also implemented and used as benchmarks against which to compare the quality of the scheme according to an embodiment of the present invention.

For efficiency, the scheme according to an embodiment was compared with that of the baseline scheme using the same oracle as the scheme of an embodiment of the present invention. This comparison will show the effect of the partitioned multi-index structure on the efficiency of finding and ranking the search results (as compared to using a simple inverted index). We used r=└8 log₂ n┘ for the scheme in all the experiments.

Datasets

Experiments were performed with four networks, two undirected and two directed, two synthetic and two from real-world data. Table 1 shown below summarizes the networks that we used.

TABLE 1
Networks used in the experiments.

| | Undirected | Directed |
|---|---|---|
| Synthetic | Grid | ForestFire |
| Real-world | Undirected Twitter | Directed Twitter |

These networks are now explained. The grid network was an 11-dimensional grid with side length 3. Associated with each node was a single word chosen uniformly at random from a dictionary of 1000 words. This network had 4¹¹>4M nodes and around 70M edges.

The ForestFire network, which had more than 1M nodes and around 2.5M edges, was generated using the ForestFire model, known to model many of the features of real world networks. Similar to the grid network, each node was associated with a single word chosen uniformly at random from a dictionary of 1000 words.

The undirected Twitter network was a sample of more than 4M nodes from the social network Twitter, and all the reciprocated edges between them. The resulting sampled network had more than 100M edges. With each node, the words in the bio and the screen name of the corresponding user were associated.

The directed Twitter network was the giant connected component of a sample of the social network Twitter. The resulting graph had over 4M nodes and more than 380M edges. Similar to the undirected case, each node the words in the bio and the screen name of the corresponding user were associated.

The samples of the twitter graph were not chosen uniformly at random, and the two samples are not the same, since a random sample would allow inference about the density of the Twitter network which Twitter considers confidential. Also, as explained below, the experiments methodology has the interesting feature that the evaluations are completely automated and do not require any human inspection of the search results, adding an additional layer of privacy and confidentiality.

Experiments Methodology and Results

Experiments were performed to study the quality and the efficiency of the scheme according to an embodiment. Here, the methodology used in these experiments as well as their results is presented. Before performing the experiments with each of the networks, the network was processed, and, for each node v, a subset C′_{V}⊂Cᵥ of its associated words was constructed. For the synthetic networks (having only a single word associated with each node), C′_{V}=Cᵥ. For the real-world networks (from Twitter), after computing, for each word ω, the frequency (i.e., the fraction) of the nodes v having ωεCᵥ, the 100 words with the largest frequencies were removed as stop words. Then, for each node v, C′_{V}, was the set composed of the following three words: the lowest frequency non-stop word on v, the highest frequency non-stop word on v, and a random non-stop word on v. The sets C′_{V} were going to later get used for constructing queries, so it was desired to assure, by including representatives from low-frequency, high-frequency, and randomly selected non-stop words, that the constructed queries would cover a wide range of possibilities.

After this preprocessing, for each experiment, a number of queries was generated. Each of these queries, q, was constructed as follows: A length l^{q}ε{2, 3} and a random node u^{q} from the graph were chosen. Then, a random walk was performed starting at u^{q} for l^{q} steps, to arrive at a node v^{q}. Then, a random word ω^{q} was chosen from C′ᵥq. Then, a query for word ω^{q} was issued by node u^{q}. In each experiment, for half the queries, l^{q}=2 was used, and for the other half, l^{q}=3 was used. Each of these queries, in accordance with the random walk based intuition behind PageRank, simulates the behavior of a random social network user starting at his own page, browsing through random links for a few steps, finding an interesting document, and then later searching for it in the hopes of finding the same page or even closer pages (in terms of social graph proximity) related to that document.

Having explained the query generation method used in all the experiments, each of the experiments as well as their results are now explained.

Quality Experiments: For each network, a set Q of 1000 queries was generated, as explained above, and the top J results, with J=1, 5, 10, were found using the scheme according to an embodiment, the random landmark scheme, and the central landmark scheme. For the scheme according to an embodiment, r=└ log₂ n┘ was chosen, and k was allowed to take all the values from 1 to 10. For each k, when comparing with the landmark-based schemes, k(r+1) landmarks were selected so they had the same preprocessing time and space as the scheme according to an embodiment of the present invention (ignoring the load of centrality computations for the central landmarks scheme).

For each scheme, finding the top J search results {{vⱼ^{q}}₁≦j≦J for each query q, the set of failed queries was considered to be:

F={qεQ|d(u^{q},v^{q})>d(u^{q},v^{q})∀1≦j≦J}

Then, denoting, for each qεQ−F, the depth of the first good result as:

j^{q}=min{1≦j≦J|d(u^{q},v^{q})≦d(u^{q},v^{q})}

the fraction of failed queries (FFQ) and the average depth of the first good result (ADFGR) are computed as the quality measures:

$$FFQ = \frac{\vert F \vert}{\vert Q \vert} , ADFGR = \frac{{\sum }_{q ∈ Q - F} {j}^{q}}{\vert Q - F}$$

One would ideally like to have:

FFQ=0,ADFGR=1

in which case, all of the queries get a good answer in the first search result. The experiments show that the scheme according to an embodiment of the present invention actually gets close to these ideals.

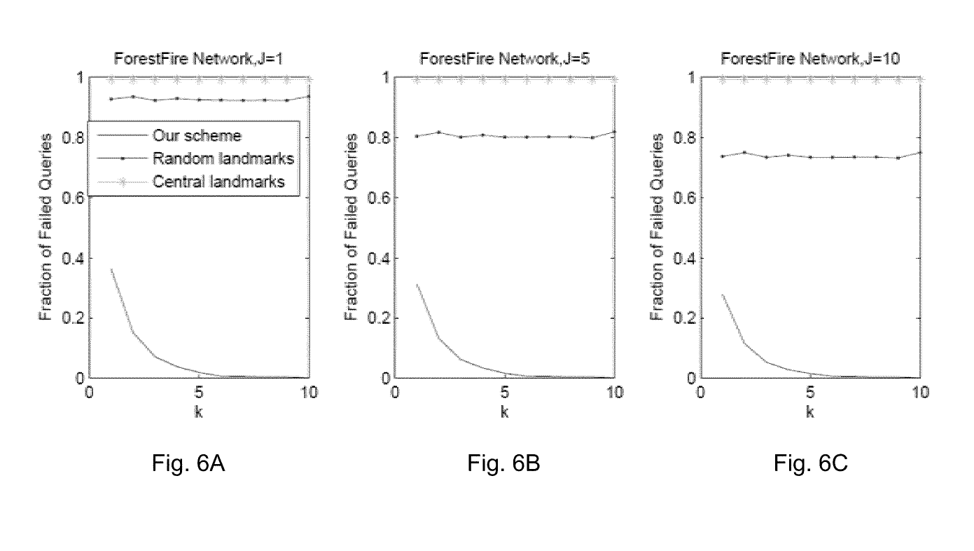

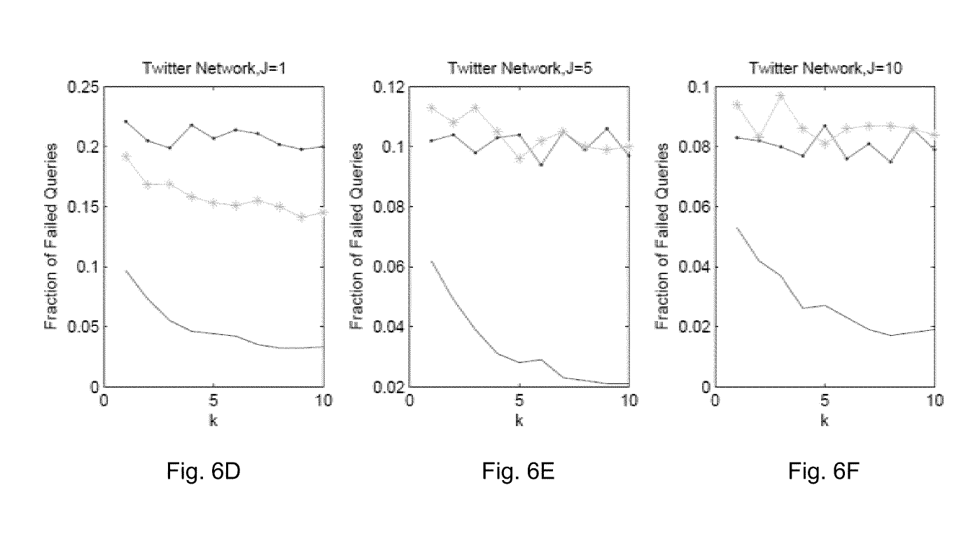

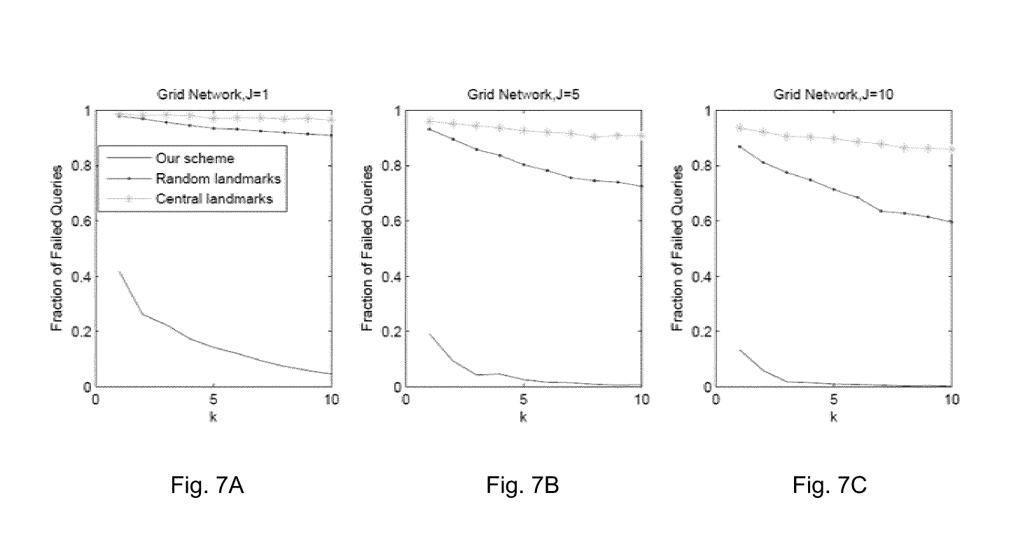

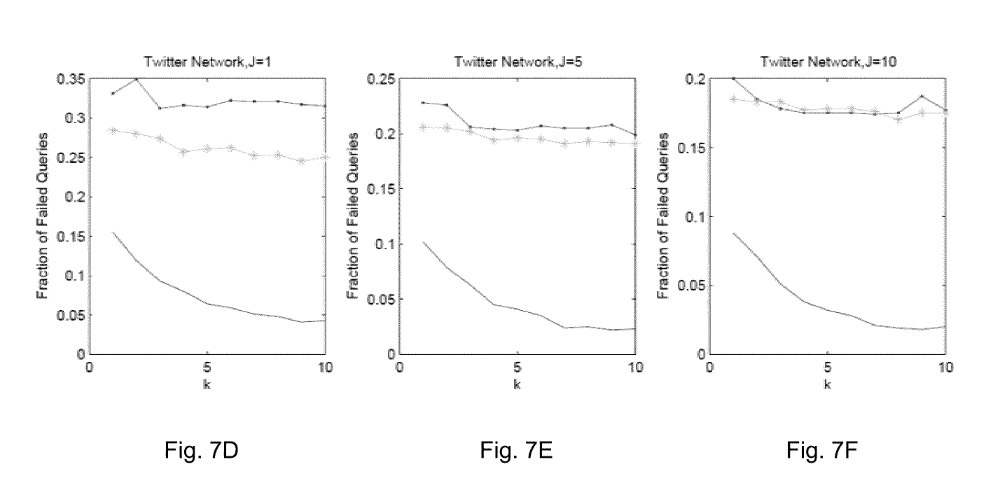

The fraction of failed queries in the experiments with the scheme according to an embodiment of the present invention and the landmark-based schemes, for Jε{1, 5, 10}, is presented in FIGS. 6A-F and 7A-F. These figures show that the scheme according to an embodiment of the present invention consistently outperforms both landmark-based schemes across all the networks, and for all the values of J. For example, FIGS. 6A-F illustrate the faction of failed queries for undirected networks. FIGS. 7A-F illustrate the faction of failed queries for directed networks.

Also, it is noted that selecting the landmarks using centralities did not help the landmark-based scheme and often even lowered its quality (as measured by FFQ). Furthermore, it is noted that increasing the number of seed sets (by increasing k) consistently improved the quality of the scheme according to an embodiment of the present invention, while increasing the number of landmarks usually did not help much with the quality of the landmark-based schemes.

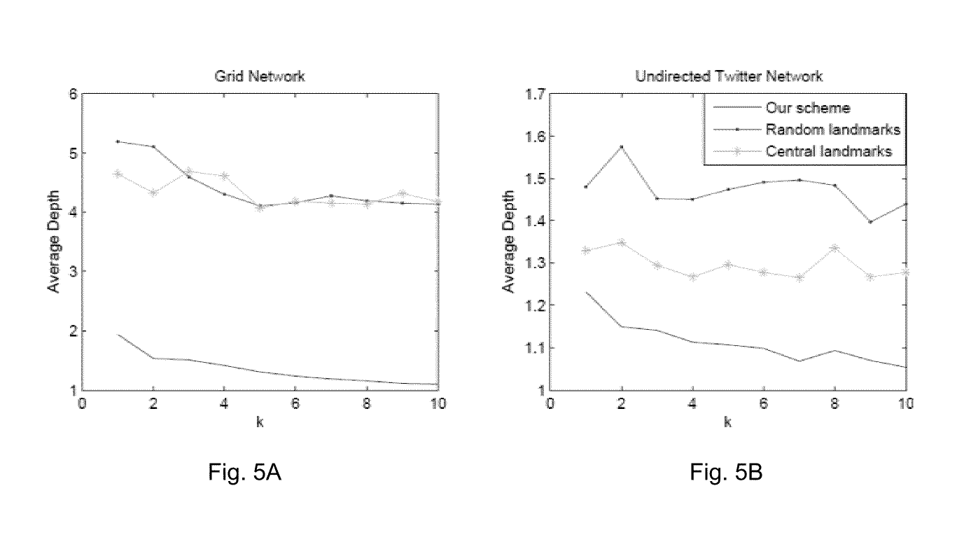

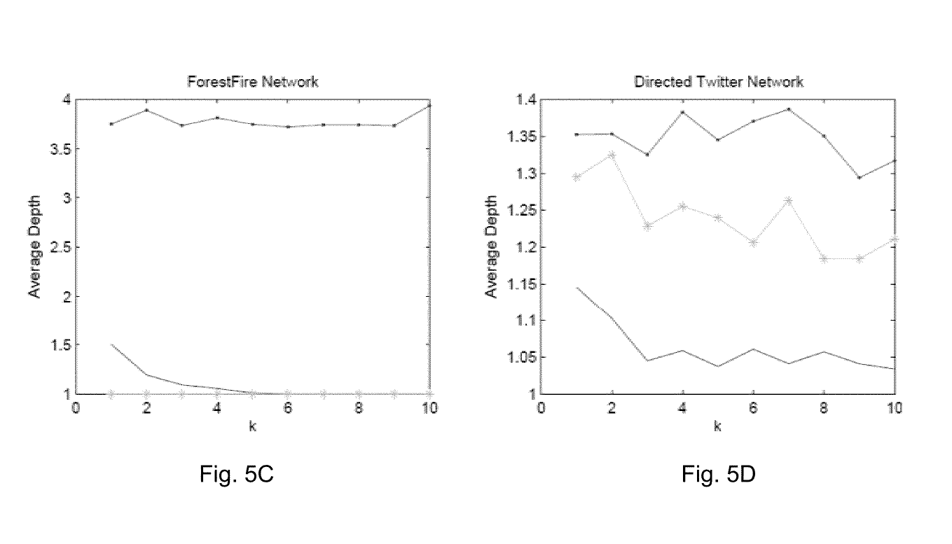

The results for ADFGR are also similar for different values of J, and hence are presented only for J=10 in FIGS. 5A-D. It is shown that across all networks, the scheme according to an embodiment of the present invention performs better than the landmark-based schemes. This, together with the results for FFQ, shows that not only the scheme according to an embodiment of the present invention finds good answers to queries more frequently, but also it does a better job in ranking those good results higher in the list of results.

Efficiency Experiments: The efficiency of the scheme according to an embodiment was compared against the benchmark provided by the baseline scheme explained above. To do so, a set of 20000 queries was generated as explained above. Letting r=└ log₂ n┘, the seed sets defining the approximate distance oracle were generated. Since the efficiencies of both the scheme according to an embodiment of the present invention and the baseline scheme are nearly linear in k, k=1 was used in the efficiency experiments. Then, for the scheme according to an embodiment of the present invention, the corresponding partitioned multi-index was constructed, and for the baseline scheme a simple inverted index of the whole network was constructed. Finally, using the constructed indices, the top 10 results for each query by each scheme were found.

As efficiency measures, the total preprocessing (sketching plus indexing) time was measured, as well as the total query time (over 20000 queries) for each scheme. The results are presented in Tables 2 and 3 below.

TABLE 2
Total preprocessing time (sec).

| | Our schme | Baseline |
|---|---|---|
| Grid Network | 58 | 18 |
| Undirected Twitter Network | 930 | 71 |
| ForestFire NetWork | 74 | 5 |
| Directed Twitter Network | 1384 | 163 |

TABLE 3
Total query time (sec) over 20000 queries.

| | Our schme | Baseline |
|---|---|---|
| Grid Network | 2 | 39 |
| Undirected Twitter Network | 1 | 61 |
| ForestFire Network | 2 | 44 |
| Directed Twitter Network | 2 | 63 |

As can be observed from these tables, even though the baseline scheme takes less preprocessing time, the scheme according to an embodiment of the present invention is still efficient at preprocessing time. Note that unlike query time which, in practice, has a harsh deadline of few milliseconds, offline preprocessing time is more flexible.

A strength of the scheme according to an embodiment of the present invention is then evident from the query time results (see Table 3) where the scheme according to an embodiment of the present invention is significantly more efficient than the baseline scheme (depending on the network, 20 to 60 times) and is insensitive to the size of the network, as predicted by the theoretical analyses.

### SUMMARY

Presented above have been many details of embodiments of the present invention. So as to more appreciate certain features of the present invention a summary of the various methods according to embodiments of the present invention are now discussed.

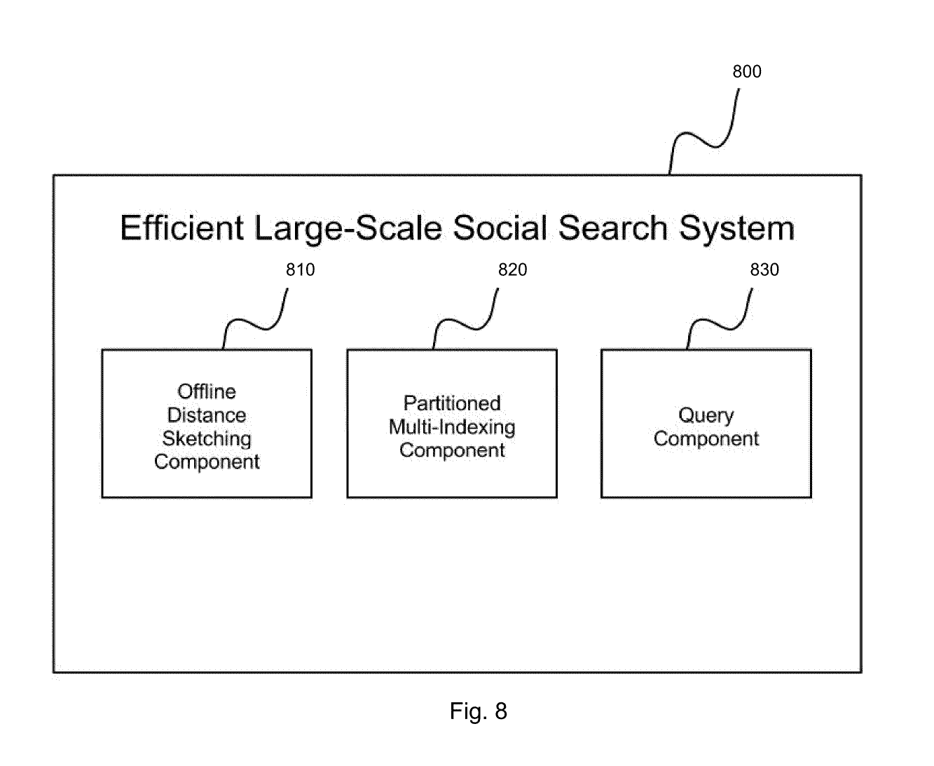

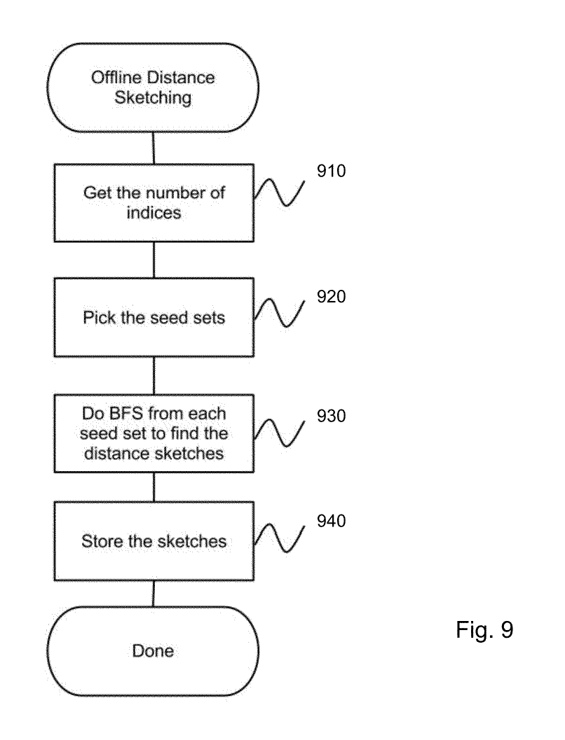

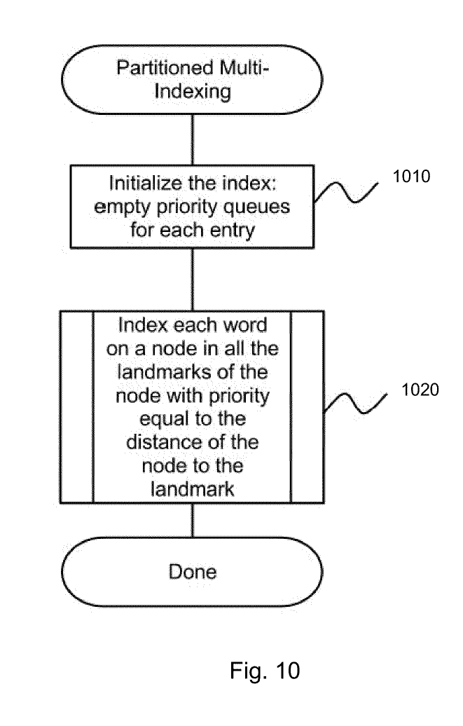

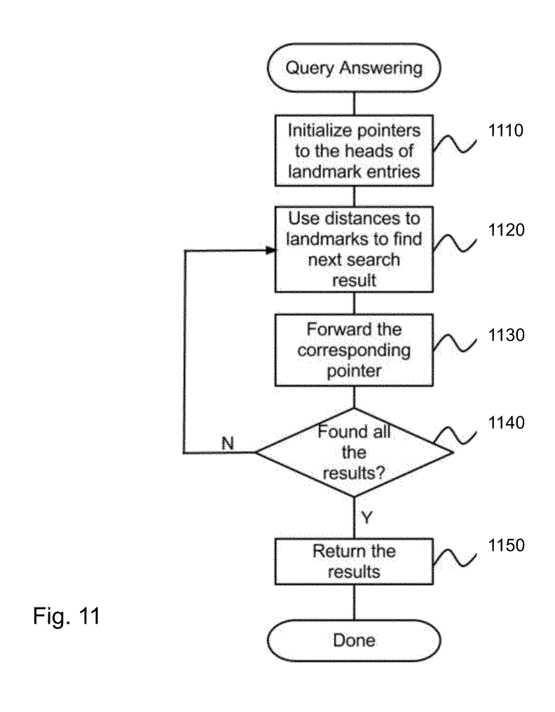

Shown in FIG. 8 is a block diagram that illustrates components of social search system 800 according to embodiment of the present invention. Those of ordinary skill in the art will understand, however, that many variations are possible without deviating from the present teachings. As shown in FIG. 8, social search system 800 includes an offline distance-sketching component 810 that is generally responsible for sketching the network graph as discussed in the methods above. Social search system 800 further includes partitioned multi-indexing component 820 that is generally responsible for indexing the network corpus as discussed in the methods above. Also, social search stems 800 includes query component 830 that is responsible for finding the search results at query time as discussed in the methods above.

Shown in FIG. 9 is a flowchart for a method for performing offline distance sketching according to an embodiment of the present invention. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

According to an embodiment of the present invention as shown in FIG. 9, at step 910, the number of indices in a graph is taken as input. Further details regarding this step and other steps are fully described above. At step 920, a number of seed sets are chosen randomly from the set of the network nodes. For example, as described above for an embodiment, a number of random seed sets S₀, . . . , Sₕ₋₁⊂V are selected where the number of these sets, h, and the cardinality of each set are specified as described above. At step 230, a Breadth First Search (BFS) is performed starting from each of the seed sets, resulting in the distance sketches for the network. For example, as described more fully above, the BFS for each node uεV, the closest node to u in Sᵢ, Lᵢ[u], as well as Dᵢ[u]=d(u, Lᵢ[u]). At step 240, the computed sketches are stored in preparation of the later real time operations.

Shown in FIG. 10 is a flowchart for a method for performing partitioned multi-indexing according to an embodiment of the present invention. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

According to an embodiment of the present invention as shown in FIG. 10, at step 1010, the index is initialized, by assigning an empty priority queue to each index entry. At step 1020, each word appearing on the document associated with each node is indexed at all the landmarks associated with the node by inserting it into the corresponding priority queue with priority equal to the distance of the node to the landmark. Further details regarding step 1020 are provided above, for example, with reference to Algorithm 3 as shown in FIG. 4.

Shown in FIG. 11 is a flowchart for a method for implementing a query answering system according to an embodiment of the present invention. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

According to an embodiment of the present invention as shown in FIG. 11, at step 1110, a pointer is initialized to point to the head of the priority queue corresponding with each landmark. For example, as described in detail above for an embodiment above, a priority queue H is initiated that will keep track of the (next) top result candidates as well as h pointers pᵢ (0≦i<h), where pᵢ points to the beginning of the sorted list PMI[i, Lᵢ[u], ω]. At step 1120, the distances to landmarks stored in the network sketch are used to find the next search result. At step 430, the pointer corresponding to the last search result is forwarded. At step 440, it is checked if all the search results are already found. If not, then the method goes back to step 420. At step 450, the found search results are returned. As discussed in further detail above, the search results are found by sweeping through the beginning nodes in the index entries being looked up. This results in a fast search algorithm at query time, and the index allows for fast incremental updates upon addition or deletion of words.

A system according to an embodiment of the present invention has an offline component and a query component. In the offline component, a number of random seed sets S₀, . . . , Sₕ₋₁ are first chosen from the set of all nodes in the network. The number of these sets, h, and the cardinality of each set is chosen as fully discussed above.

For any node u in the network, and any 0≦i<h, a method according to an embodiment of the present invention finds L jut the closest node to u among all the nodes in Sᵢ, and Dᵢ[u], the distance from u to Lᵢ[u]. In an embodiment, this can be computed using h calls to a breadth-first search subroutine as shown in FIG. 9.

For any 0≦i<h, and any node x in Sᵢ, as shown in FIG. 10, an inverted index I_{i,x} is constructed over all documents stored at nodes v which are closer to x than to any other node in Sᵢ. For each indexed word w, the corresponding list of nodes, I_{i,x}(w), is kept in the increasing order of their distances to x, and these distances are stored in the list.

At query time, when a node u issues a query, as shown in FIG. 11, the indexes Ii,Lᵢ[u](0≦i≦h−1) are used, e.g., intuitively speaking, the closest indexes to u, to find the search results. Since u is closer to Lᵢ[u] than to any other node in Sᵢ, and also the nodes in each entry of Ii,Lᵢ[u] are sorted in terms of their distance to Lᵢ[u], then at query time, the search results can be found by sweeping through the beginning nodes of the index entries being looked up.

It should be appreciated by those skilled in the art that the specific embodiments disclosed above may be readily utilized as a basis for modifying or designing other image processing algorithms or systems. It should also be appreciated by those skilled in the art that such modifications do not depart from the scope of the invention as set forth in the appended claims.

What is claimed is:

1. A computerized method for performing a search query, comprising:
performing an offline distance sketch for nodes in a graph;
performing a partitioned multi-index on selected words on a node of the graph;
receiving a search query;
using distance measures to find a set of search results responsive to the query.

2. The method of claim 1, wherein performing the offline distance sketch comprises
receiving a number for indices of the graph;
selecting a plurality of seed sets;
performing a search from each seed set;
determining a set of distance sketches.

3. The method of claim 2, wherein the search is a breadth first search.

4. The method of claim 2, wherein the search is a depth first search.

5. The method of claim 2, further comprising storing the distance sketches.

6. The method of claim 1, wherein performing a partitioned multi-index comprises
initializing an index;
emptying priority queues for each entry in the index; and
indexing each word on a node that meets a predetermined criteria.

7. The method of claim 6, wherein the predetermined criteria is a priority that is equal to a distance of a selected node to a selected landmark.

8. The method of claim 1, wherein performing an offline distance sketch is performed offline.

9. The method of claim 1, wherein the offline distance sketch is performed prior to receiving the search query.

10. The method of claim 1, wherein the search query is performed on a social network.

11. A computer-readable medium including instructions that, when executed by a processing unit, cause the processing unit to implement a method for performing a search query, by performing the steps of:
performing an offline distance sketch for nodes in a graph;
performing a partitioned multi-index on selected words on a node of the graph;
receiving a search query;
using distance measures to find a set of search results responsive to the query.

12. The computer-readable medium of claim 11, wherein performing the offline distance sketch comprises
receiving a number for indices of the graph;
selecting a plurality of seed sets;
performing a search from each seed set;
determining a set of distance sketches.

13. The computer-readable medium of claim 12, wherein the search is a breadth first search.

14. The computer-readable medium of claim 12, wherein the search is a depth first search.

15. The computer-readable medium of claim 12, further comprising storing the distance sketches.

16. The computer-readable medium of claim 11, wherein performing a partitioned multi-index comprises
initializing an index;
emptying priority queues for each entry in the index; and
indexing each word on a node that meets a predetermined criteria.

17. The computer-readable medium of claim 16, wherein the predetermined criteria is a priority that is equal to a distance of a selected node to a selected landmark.

18. The computer-readable medium of claim 11, wherein performing an offline distance sketch is performed offline.

19. The computer-readable medium of claim 11, wherein the offline distance sketch is performed prior to receiving the search query.

20. The computer-readable medium of claim 11, wherein the search query is performed on a social network.

21. A computing device comprising:
a data bus;
a memory unit coupled to the data bus;
at least one processing unit coupled to the data bus and configured to
perform an offline distance sketch for nodes in a graph;
perform a partitioned multi-index on selected words on a node of the graph;
receive a search query;
use distance measures to find a set of search results responsive to the query.
